(19) United States
(12) Patent Application Publication
(10) Pub. No.: US 2015/0256267 A1
(43) Pub. Date: Sep. 10, 2015

(54) OPTICAL RECEIVER HAVING A DIGITAL CHROMATIC-DISPERSION COMPENSATOR BASED ON REAL-VALUED ARITHMETIC

(71) Applicant: Alcatel-Lucent USA Inc., Murray Hill, NJ (US)

(72) Inventor: Sebastian A. Randel, Aberdeen, NJ (US)

(73) Assignee: ALCATEL-LUCENT USA INC., Murray Hill, NJ (US)

(21) Appl. No.: 14/200,506

(22) Filed: Mar. 7, 2014

(51) Int. Cl. H04B 10/61

(52) U.S. Cl. CPC H04B 10/6161

(57) ABSTRACT

An optical receiver comprising an optical-to-electrical converter and a digital processor having first and second equalizer stages. The optical-to-electrical converter is configured to mix an optical input signal and an optical reference signal to generate a plurality of electrical digital measures of the optical input signal. The digital processor is configured to process the electrical digital measures to recover the data carried by the optical input signal. The first equalizer stage in the digital processor is configured to perform chromatic-dispersion-compensation processing in a manner that does not mix different electrical digital measures prior to signal-equalization processing in the second equalizer stage, which enables the first equalizer stage to operate using real-valued arithmetic. These characteristics of the first equalizer stage enable the second equalizer stage to more-effectively mitigate signal impairments for signals received through CD-impaired optical-transport links because various orthogonality-degrading effects can now be tracked and compensated more accurately therein.

### BACKGROUND

1. Field

The present disclosure relates to optical communication equipment and, more specifically but not exclusively, to an optical receiver having a digital chromatic-dispersion compensator based on real-valued arithmetic.

2. Description of the Related Art

This section introduces aspects that may help facilitate a better understanding of the disclosure. Accordingly, the statements of this section are to be read in this light and are not to be understood as admissions about what is in the prior art or what is not in the prior art.

Chromatic dispersion (CD) is one of the most-common impairments in fiber-optic transmission systems. In coherent transmission, CD can be compensated using a digital signal processor, e.g., implemented as an application specific integrated circuit (ASIC) located in the back end of an optical receiver. One of the technical problems that the designers of coherent optical receivers attempt to solve is to improve the ASIC's ability to efficiently mitigate the effects of other signal impairments in addition to the effects of CD.

### SUMMARY OF SOME SPECIFIC EMBODIMENTS

Disclosed herein are various embodiments of an optical receiver comprising an optical-to-electrical converter and a digital processor having first and second equalizer stages. The optical-to-electrical converter is configured to mix an optical input signal and an optical local-oscillator signal to generate a plurality of electrical digital measures of the optical input signal. The digital processor is configured to process the electrical digital measures to recover the data carried by the optical input signal. The first equalizer stage in the digital processor is configured to perform chromatic-dispersion-compensation processing in a manner that does not mix different electrical digital measures prior to signal-equalization processing in the second equalizer stage, which enables the first equalizer stage to operate using only real-valued arithmetic. The signal-equalization processing in the second equalizer stage may be configured to perform one or more of the following: (i) I/Q signal-imbalance and/or skew correction; (ii) polarization de-multiplexing; and (iii) signal processing directed at reducing the adverse effects of polarization-mode dispersion, polarization-dependent loss, inter-symbol interference, residual chromatic dispersion, and any difference in the linear responses of the I and Q signal paths. The aforementioned characteristics of the first equalizer stage enable the digital processor to more-effectively mitigate signal impairments for signals received through optical-transport links having significant amounts of chromatic dispersion because various orthogonality-degrading effects can now be tracked and compensated more accurately in the second equalizer stage.

According to an example embodiment, provided is an apparatus comprising: an optical-to-electrical converter configured to mix an optical input signal and an optical reference signal to generate a first plurality of electrical digital measures of the optical input signal; and a digital processor configured to process the first plurality of electrical digital measures to recover data encoded in the optical input signal. The digital processor comprises: a first equalizer stage configured to perform chromatic-dispersion-compensation processing on the first plurality of electrical digital measures to generate a second plurality of electrical digital measures of the optical input signal; and a second equalizer stage configured to perform signal-equalization processing on the second plurality of electrical digital measures to generate one or more complex-valued digital measures of the optical input signal. The digital processor is configured to generate the second plurality of electrical digital measures in a manner that does not mix different electrical digital measures of the first plurality of electrical digital measures prior to the signal-equalization processing in the second equalizer stage. The digital processor is configured to recover the data carried by the optical input signal based on the one or more complex-valued digital measures.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of a coherent optical receiver according to an embodiment of the disclosure;

FIG. 2 shows a block diagram of a digital circuit that can be used in the coherent optical receiver of FIG. 1 according to an embodiment of the disclosure;

FIG. 3 shows a block diagram of a filter bank that can be used in place of CDC modules in the digital circuit of FIG. 2 according to an embodiment of the disclosure;

FIG. 4 shows a block diagram of an individual equalization filter that can be used in the filter bank shown in FIG. 3 according to an embodiment of the disclosure;

FIG. 5 shows a block diagram of an individual equalization filter that can be used in the filter bank shown in FIG. 3 according to an alternative embodiment of the disclosure; and

FIG. 6 shows a block diagram of an equalizer that can be used in the digital circuit of FIG. 2 according to an embodiment of the disclosure.

### DETAILED DESCRIPTION

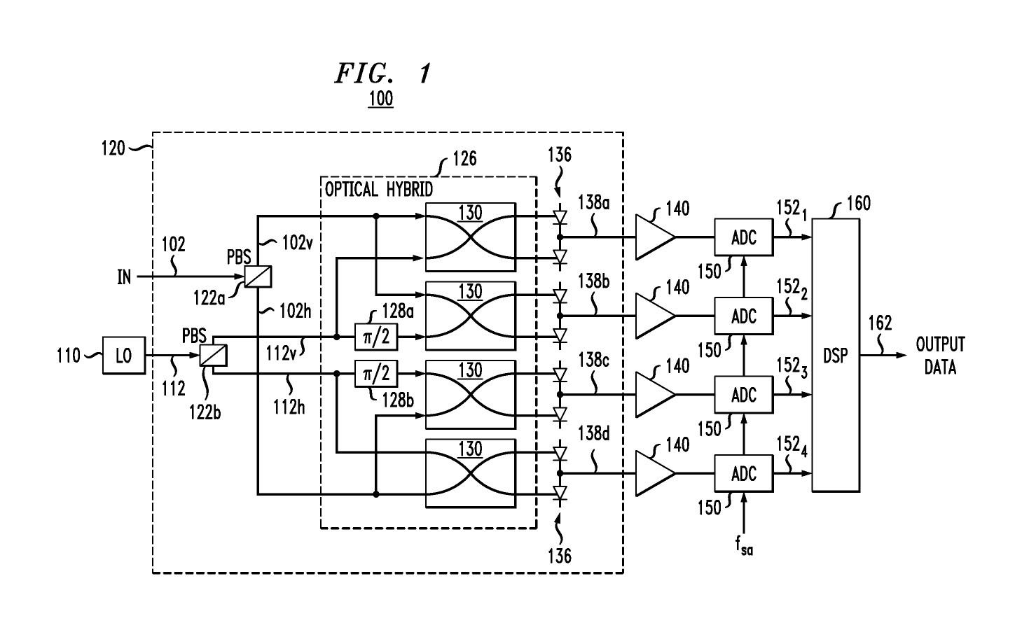

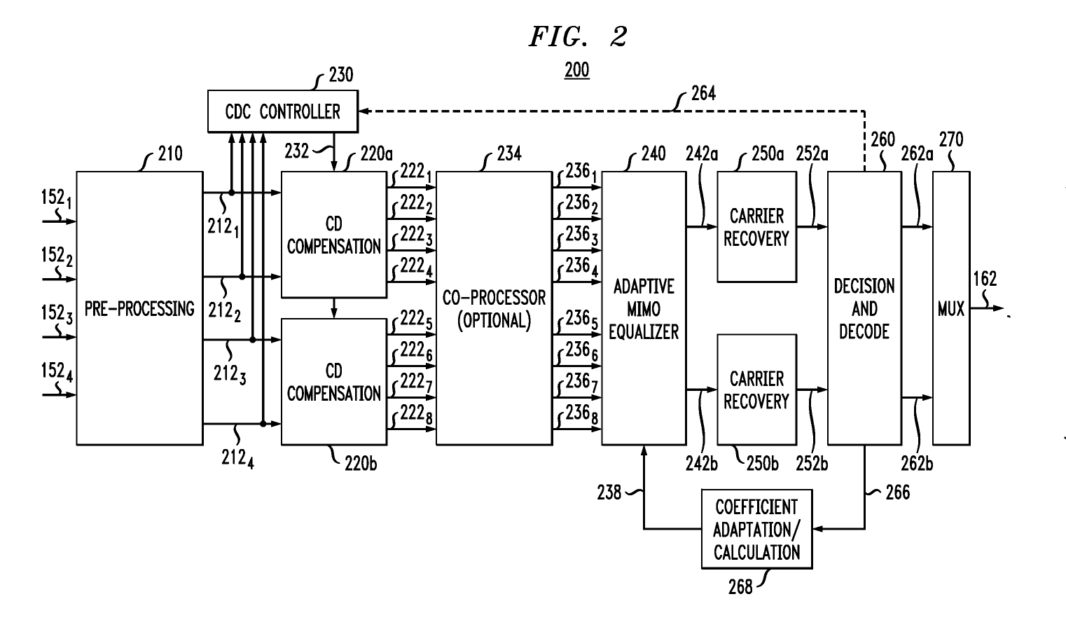

FIG. 1 shows a block diagram of a coherent optical receiver 100 according to an embodiment of the disclosure. Receiver 100 receives an optical input polarization-division multiplexed (PDM) signal 102, e.g., from a remote transmitter, via an external optical transport link (not explicitly shown in FIG. 1). Optical input signal 102 is applied to an optical-to-electrical (O/E) converter 120 that converts that optical signal into four analog electrical signals 138a-138d. Each of signals 138a-138d may be amplified in a corresponding amplifier 140 coupled to a corresponding analog-to-digital (A/D) converter (ADC) 150. Each A/D converter 150 samples the output of the corresponding amplifier 140 at an appropriate sampling frequency (fₛₐ) to produce a corresponding one of four digital electrical signals 152₁-152₄. Digital signals 152₁-152₄ are applied to a digital signal processor (DSP) 160 that processes them, e.g., as described in more detail below in reference to FIGS. 2-6, to recover the data streams originally encoded onto the PDM components of optical input signal 102 at the remote transmitter. DSP 160 then outputs the recovered data streams via an output signal 162.

In one embodiment, receiver 100 may include a set of electrical low-pass filters (not explicitly shown in FIG. 1), each inserted between O/E converter 120 and the respective one of A/D converters 150. The use of these filters may help to reduce noise and prevent aliasing.

O/E converter 120 implements a polarization-diversity intradyne-detection scheme using an optical local-oscillator (LO) signal 112 generated by an optical LO source 110. Polarization beam splitters (PBSs) 122a and 122b decompose signals 102 and 112, respectively, into two respective orthogonally polarized components, illustratively vertically polarized components 102v and 112v and horizontally polarized components 102h and 112h. These polarization components are then directed to an optical hybrid 126.

In optical hybrid 126, each of polarization components 102v, 112v, 102h, and 112h is split into two (attenuated) copies, e.g., using a conventional 3-dB power splitter (not explicitly shown in FIG. 1). A relative phase shift of about 90 degrees (π/2 radian) is then applied to one copy of component 112v and one copy of component 112h using phase shifters 128a-128b, respectively. The various copies of signals 102v, 112v, 102h, and 112h are optically mixed with each other as shown in FIG. 1 using four optical signal mixers 130, and the mixed signals produced by the mixers are detected by eight photo-detectors (e.g., photodiodes) 136. Photo-detectors 136 are arranged in pairs, as shown in FIG. 1, and the output of each photo-detector pair is a corresponding one of electrical signals 138a-138d. This configuration of photo-detectors 136 is a differential configuration that helps to reduce noise and improve DC balancing. In an alternative embodiment, O/E converter 120 can have four photo-detectors 136, one per optical signal mixer 130, configured for single-ended detection of the corresponding optical signals.

Example optical hybrids that are suitable for use in optical receiver 100 are described, e.g., in U.S. Patent Application Publication Nos. 2007/0297806 and 2011/0038631, both of which are incorporated herein by reference in their entirety.

In an example embodiment, DSP 160 is configured to perform CD-compensation (CDC) processing, e.g., as further described below. In addition to the CDC processing, DSP 160 may be configured to perform other signal processing, such as (i) signal equalization and (ii) carrier- and data-recovery processing. Signal equalization is generally directed at reducing the detrimental effects of various additional signal impairments imparted onto the received optical signal in the optical transport link. Such additional signal impairments might include, but are not limited to polarization distortion or rotation, polarization-mode dispersion (PMD), additive noise, and spectral distortion. One of ordinary skill in the art will appreciate that these signal impairments might accrue in the optical link through either localized or distributed mechanisms, or through a combination of both types of mechanisms. The carrier- and data-recovery processing is generally directed at reducing the detrimental effects of the frequency mismatch between the carrier frequencies of optical LO signal 112 and input signal 102, phase noise, and/or local-oscillator phase error to enable receiver 100 to recover the transmitted data with a relatively low BER. Description of the additional signal processing that can be implemented in DSP 160 according to various embodiments of the disclosure can be found, e.g., in U.S. Patent Application Publication No. 2013/0230312 and U.S. patent application Ser. No. 13/628,412 (attorney docket ref. 811303-US-NP, filed on Sep. 27, 2012) and U.S. Ser. No. 13/729,403 (attorney docket ref. 812179-US-NP, filed on Dec. 28, 2012), all of which are incorporated herein by reference in their entirety.

Ideally, digital signals 152₁-152₂ represent the I and Q components, respectively, of the first PDM (e.g., X-polarized) component of the original optical communication signal generated by the remote transmitter, and digital signals 152₃-152₄ represent the I and Q components, respectively, of the second PDM (e.g., Y-polarized) component of that optical communication signal. However, the often-present misalignment between the principal polarization axes of the remote transmitter and the principal polarization axes of receiver 100 and polarization rotation in the optical fiber generally cause each of digital signals 152₁-152₄ to be a convoluted signal that has signal distortions and/or contributions from both of the original PDM components. Conventional signal-equalization processing treats digital signals 152₁-152₄ as being linear combinations of two pairs of I/Q signals, with the I and Q signals in each pair being phase-locked with respect to one another with a relative phase shift of 90 degrees. In contrast, the signal-equalization processing implemented in DSP 160 is configured to treat digital signals 152₁-152₄ as being linear combinations of arbitrarily coupled (e.g., not necessarily 90-degree phase-locked) signals. An additional feature of DSP 160 is that a CDC module of the DSP is configured to use exclusively real-valued arithmetic, which enables the CDC module not to mix the I and Q signals. These features enable DSP 160 to more-fully compensate the transmitter-, receiver-, and link-induced signal impairments, e.g., because various orthogonality-degrading effects can now be more-precisely taken into account and better compensated in receiver 100.

FIG. 2 shows a block diagram of a digital circuit 200 that can be used in DSP 160 (FIG. 1) according to an embodiment of the disclosure. Digital circuit 200 is illustratively shown in FIG. 2 as being configured to (i) receive digital signals 152₁-152₄ and (ii) generate the recovered data stream 162 (also see FIG. 1). In alternative embodiments, additional signal-processing modules may be used, e.g., to condition digital signals 152₁-152₄ prior to their application to digital circuit 200.

Digital circuit 200 has an optional pre-processing module 210 configured to process digital signals 152₁-152₄ to convert them into digital signals 212₁-212₄, respectively. One function of module 210 may be to adapt the signal samples received via digital signals 152₁-152₄ to a form that is better suitable for the signal-processing algorithms implemented in the downstream modules of digital circuit 200. For example, module 210 may be configured to re-sample digital signals 152₁-152₄ to a sample rate that equals twice the symbol rate (e.g., two samples per symbol).

In one embodiment, module 210 may also be configured to reduce signal distortions imposed by the front-end of receiver 100 (FIG. 1). Said distortions may be caused, e.g., by incorrect biasing of various electro-optical components in O/E converter 120, imperfect signal splitting in power and polarization splitters and optical couplers, frequency dependence and variability of the O/E conversion characteristics of the photo-detectors, etc. Representative signal-processing methods that can be implemented in module 210 for this purpose are disclosed, e.g., in commonly owned U.S. Patent Application Publication No. 2012/0057863, which is incorporated herein by reference in its entirety.

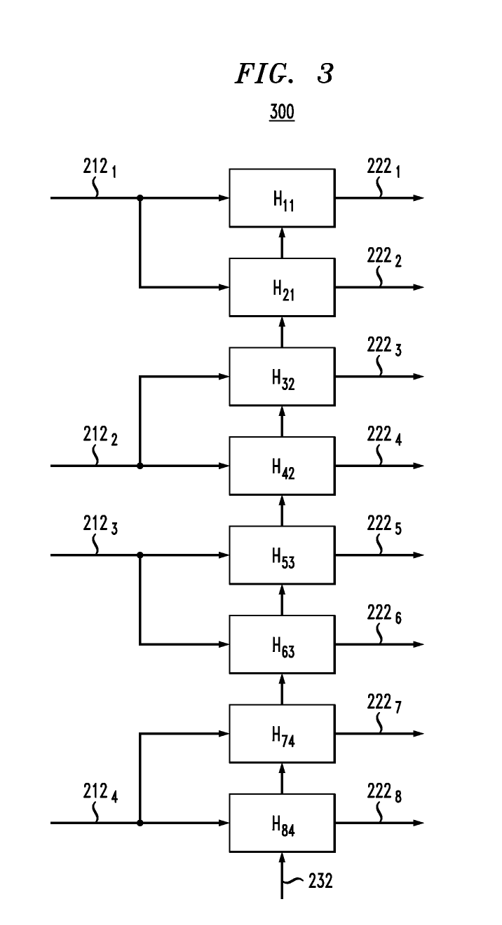

Digital signals 212₁-212₄ are applied to CDC modules 220a and 220b, as indicated in FIG. 2, for CDC processing therein. The resulting CDC-processed signals generated by CDC modules 220a and 220b are real-valued digital signals 222₁-222₈. More specifically, digital signals 222₁-222₂ are generated by CDC module 220a from digital signal 212₁. Digital signals 222₃-222₄ are generated by CDC module 220a from digital signal 212₂. Digital signals 222₅-222₆ are generated by CDC module 220b from digital signal 212₃. Digital signals 222₇-222₈ are generated by CDC module 220b from digital signal 212₄. As such, CDC modules 220a and 220b do not mix the various ones of digital signals 212₁-212₄ in the process of generating digital signals 222₁-222₈. Additional details on the structure and operation of CDC modules 220a and 220b according to various embodiments of the disclosure are provided below in reference to FIGS. 3-5.

A CDC controller 230 serves to generate a control signal 232 that appropriately configures various configurable elements within CDC modules 220a and 220b to significantly reduce or substantially cancel the detrimental effects of chromatic dispersion caused by the optical transport link. CDC controller 230 generates control signal 232 by estimating the group delay in the optical transport link based on digital signals 212₁-212₄ and, optionally, a feedback signal 264 received from one or more downstream modules of digital circuit 200, e.g., as indicated in FIG. 2. Example signal-processing methods that can be adapted for generating control signal 232 in digital circuit 200 are disclosed, e.g., in U.S. Pat. Nos. 8,260,154, 7,636,525, 7,266,310, all of which are incorporated herein by reference in their entirety.

Digital signals 222₁-222₈ generated by CDC modules 220a and 220b are applied to an optional co-processor 234. Example functions that may be performed by co-processor 234 include timing recovery and frame synchronization. Circuits and signal-processing methods that can be used to implement co-processor 234 are disclosed, e.g., in U.S. Pat. Nos. 8,515,286 and 8,660,433, both of which are incorporated herein by reference in their entirety.

Note that the signal processing performed in co-processor 234 may or may not alter digital signals 222₁-222₈ that it receives from CDC modules 220a and 220b. In any case, the digital signals that are passed on to the circuits located downstream from optional co-processor 234 are designated in FIG. 2 as signals 236₁-236₈.

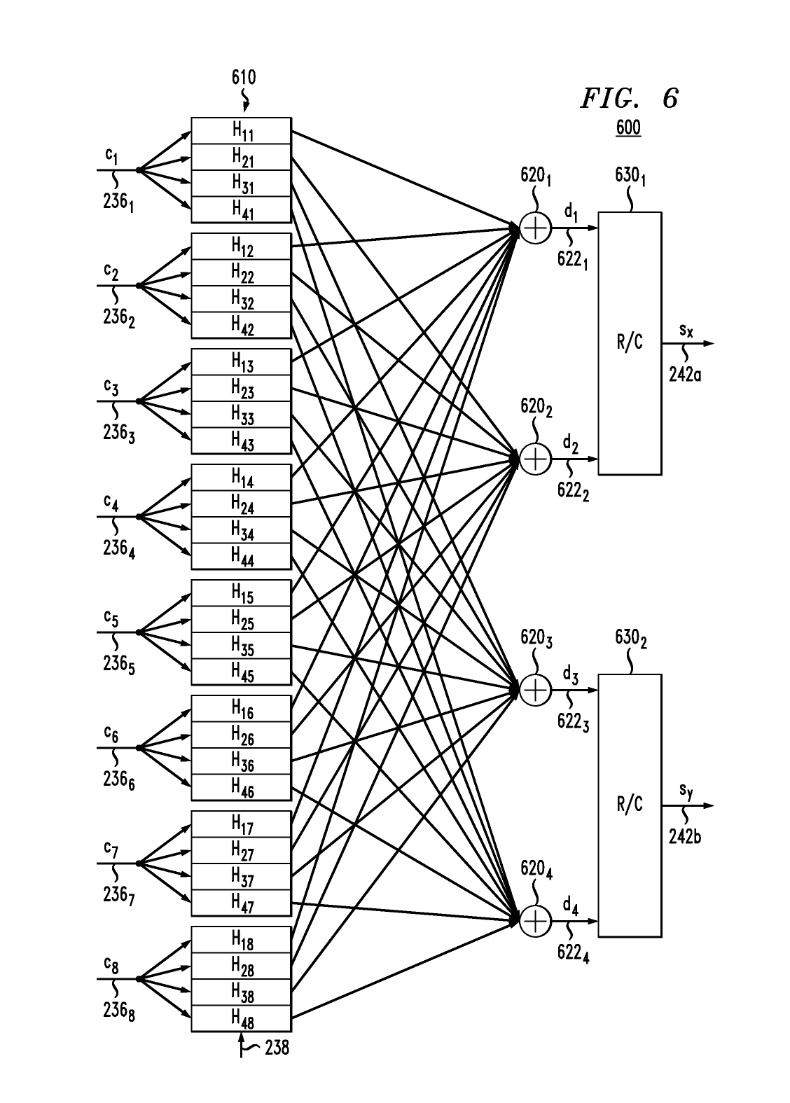

Digital signals 236₁-236₈ are applied to an adaptive MIMO (multiple-input/multiple-output) equalizer 240 for MIMO-equalization processing therein, and the resulting equalized signals are complex-valued digital signals 242a and 242b. An example embodiment of MIMO equalizer 240 is described below in reference to FIG. 6. Some embodiments of MIMO equalizer 240 may benefit from the use of MIMO-equalization processing methods and circuits disclosed in U.S. patent application Ser. No. 13/729,403, by Sebastian A. Randel, et al., filed on Dec. 28, 2012, and entitled “OPTICAL RECEIVER HAVING A MIMO EQUALIZER,” which is incorporated herein by reference in its entirety.

In various, embodiments MIMO equalizer 240 may be configured to perform one or more of the following: (i) I/Q signal-imbalance correction; (ii) polarization de-multiplexing; and (iii) signal processing directed at reducing the adverse effects of polarization-mode dispersion (PMD), polarization-dependent loss (PDL), inter-symbol interference (ISI), and residual CD. An equalizer controller 268 serves to calculate various filter coefficients for MIMO equalizer 240 based on a feedback signal 266 received from one or more downstream modules of digital circuit 200, e.g., as indicated in FIG. 2. In an alternative embodiment, feedback signal 266 can be based on digital signals 242a and 242b. The calculated coefficients are then communicated to MIMO equalizer 240 via a control signal 238.

Digital signals 242a and 242b generated by MIMO equalizer 240 are applied to carrier-recovery modules 250a and 250b, respectively. Together with a decision and decode (DD) circuit 260, carrier-recovery modules 250a and 250b carry out the above-mentioned carrier- and data-recovery processing, which is generally directed at compensating the frequency mismatch between the carrier frequencies of optical LO signal 112 and optical input signal 102, reducing the effects of phase noise, and recovering the transmitted data. Various signal-processing techniques that can be used to implement the frequency-mismatch compensation are disclosed, e.g., in U.S. Pat. No. 7,747,177 and U.S. Patent Application Publication No. 2008/0152361, both of which are incorporated herein by reference in their entirety. Representative signal-processing techniques that can be used to implement phase-error correction are disclosed, e.g., in the above-cited U.S. Patent Application Publication No. 2013/0230312.

Digital signals 252a and 252b generated by carrier-recovery modules 250a and 250b, respectively, are applied to DD circuit 260. DD circuit 260 uses the complex values conveyed by digital signals 252a and 252b to appropriately map each received symbol onto an operative constellation and, based on said mapping, recover the corresponding encoded data. In one embodiment, DD circuit 260 may perform digital processing that implements error correction based on data redundancies (if any) in optical input signal 102. Many forward-error-correction (FEC) methods suitable for this purpose are known in the art. Several examples of such methods are disclosed, e.g., in U.S. Pat. Nos. 7,734,191, 7,574,146, 7,424,651, 7,212,741, and 6,683,855, all of which are incorporated herein by reference in their entirety.

DD circuit 260 outputs the data recovered from digital signals 252a and 252b via data streams 262a and 262b, respectively. A multiplexer (MUX) 270 then appropriately multiplexes data streams 262a and 262b to generate the recovered data stream 162.

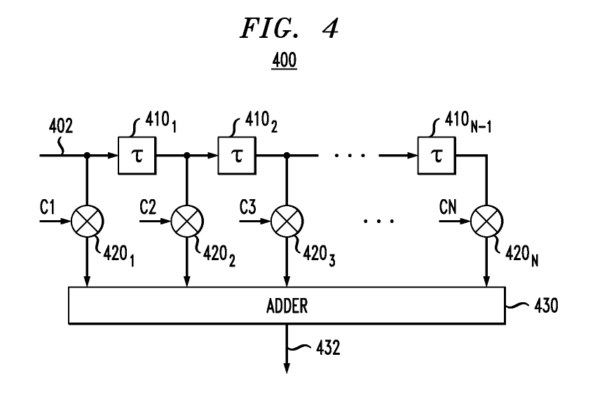

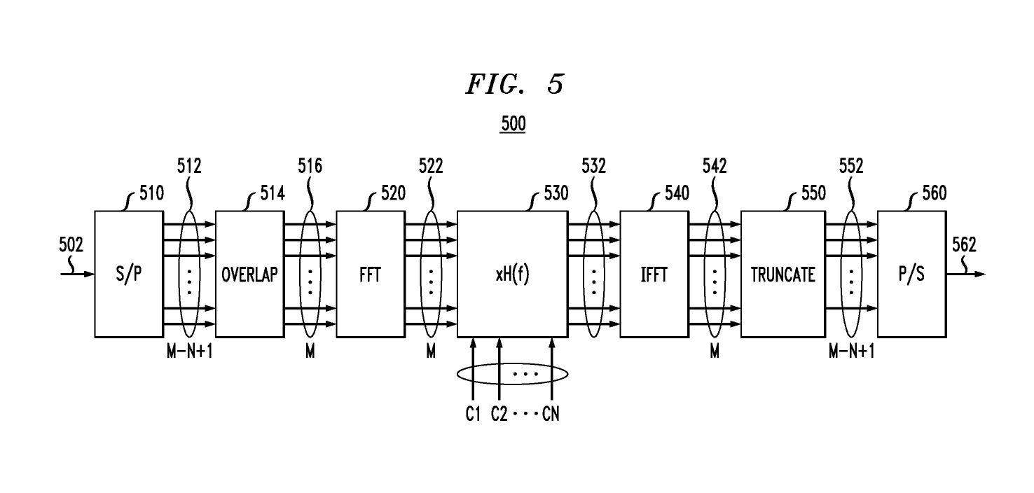

FIG. 3 shows a block diagram of a filter bank 300 that can be used in place of CDC modules 220a and 220b (FIG. 2) according to an embodiment of the disclosure. Filter bank 300 comprises eight equalization filters, each marked in FIG. 3 using the filter's transfer function, Hᵢₖ, where i=1, 2, . . . , 8 and k=1, 2, 3, 4. Possible embodiments of individual equalization filters used in filter bank 300 are described in more detail below in reference to FIGS. 4-5.

In mathematical terms, filter bank 300 implements the signal transform expressed by Eq. (1):

$${b}_{i} = {\sum }_{k = 1}^{4} {H}_{ik} * {a}_{k} \qquad ( 1 )$$

where bᵢ is the i-th component of output vector B, where i=1, 2, . . . , 8; aₖ is the k-th component of input vector A, where k=1, 2, 3, 4; Hᵢₖ is a transfer function of the respective filter; and the “*” symbol denotes the convolution operation. In each time slot, input-vector component aₖ has a value provided by digital signal 212ₖ, and digital signal 222ᵢ carries a corresponding value of output-vector component bᵢ. Of the thirty-two possible transfer functions Hᵢₖ in Eq. (1), only the eight transfer functions indicated in FIG. 3 are non-zero, and the remaining ones are all zero. All non-zero transfer functions Hᵢₖ are real-valued. Non-zero transfer functions Hᵢₖ are controlled by a CDC controller 230, via a control signal 232, and are typically frequency dependent. Control signal 232 is a multi-component control signal that can be updated relatively infrequently because, in a fixed optical link, CD is a quasi-static phenomenon.

In one embodiment, the non-zero transfer functions Hᵢₖ indicated in FIG. 3 may be interrelated in accordance with Eqs. (2a)-(2b):

H₁₁=H₄₂=H₅₃=H₈₄ (2a)

H₂₁=−H₃₂=H₆₃=−H₇₄ (2b)

The relationship between transfer functions Hᵢₖ expressed by Eqs. (2a)-(2b) is beneficial for a situation in which the CD that is being compensated is polarization independent. If the link-transfer function associated with CD is H_{CD}, then filter bank 300 may be configured to approximate an inverse link-transfer function, (H_{CD})⁻¹=H_{RE}+j H_{IM}, such that each of the transfer functions in Eq. (2a) approximates the real part H_{RE} of the inverse link-transfer function, and each of the transfer functions in Eq. (2b) approximates the imaginary part H_{IM} of the inverse link-transfer function.

In another embodiment, the non-zero transfer functions Hᵢₖ indicated in FIG. 3 may be interrelated in accordance with Eqs. (3a)-(3d):

H₁₁=H₄₂ (3a)

H₂₁=−H₃₂ (3b)

H₅₃=H₈₄ (3c)

H₆₃=−H₇₄ (3d)

The relationship between transfer functions Hᵢₖ expressed by Eqs. (3a)-(3d) is beneficial for a situation in which the CD that is being compensated is polarization dependent.

FIG. 4 shows a block diagram of a finite-impulse-response (FIR) filter 400 that can be used to implement any of the eight equalization filters in filter bank 300 (FIG. 3) according to an embodiment of the disclosure. Filter 400 is configured to receive an input signal 402 and generate a filtered output signal 432. When filter 400 is used as equalization filter [Hᵢₖ] in filter bank 300, input signal 402 is a copy of digital signal 212ₖ, and filtered output signal 432 is digital signal 222ᵢ (see FIG. 3).

Filter 400 is an N-tap FIR filter comprising (i) N−1 delay elements 410₁-410_{N-1}; (ii) N multipliers 420₁-420_{N}; and (iii) an adder 430. Each of delay elements 410₁-410_{N-1} is configured to introduce a time delay τ, which can be equal to the duration of one (or an integer multiple of a) sample period. Each of multipliers 420₁-420_{N} is configured to multiply a corresponding delayed copy of input signal 402 by a respective real-valued coefficient Cₙ, where i=1, 2, . . . , N. Adder 430 is configured to sum the output signals generated by multipliers 420₁-420_{N} to generate filtered output signal 432. In one embodiment, the number (N) of taps in filter 400 can be between two and twelve. In an alternative embodiment, a significantly larger number of taps, e.g., about five hundred, can similarly be used.

The values of coefficients C₁-C_{N} applied by multipliers 420₁-420_{N} can be changed over time and are set, e.g., by CDC controller 230 via control signal 232 (see FIG. 2). In operation, different instances (copies) of FIR filter 400 in filter bank 300 (FIG. 3) may be configured to use different respective sets of coefficients C₁-C_{N}.

FIG. 5 shows a block diagram of a frequency-domain equalization filter 500 that can be used to implement any of the eight equalization filters in filter bank 300 (FIG. 3) according to an alternative embodiment of the disclosure. Filter 500 is configured to receive an input signal 502 and to generate a filtered output signal 562. When filter 500 is used as equalization filter [Hᵢₖ] in filter bank 300, input signal 502 is a copy of digital signal 212ₖ, and filtered output signal 562 is digital signal 222ᵢ (see FIG. 3).

As the name of filter 500 implies, this filter is designed to apply a frequency-dependent transfer function, H(ƒ), in the frequency domain, where f is frequency. Accordingly, filter 500 includes a fast Fourier-transform (FFT) module 520 and an inverse-FFT (IFFT) module 540, with a transfer-function-application module (xH(ƒ)) 530 sandwiched between these two modules. CDC controller 230 and control signal 232 (see FIG. 2) can be used to control transfer-function-application module 530 in a manner similar to that used for the control of multipliers 420₁-420_{N} in filter 400 (FIG. 4). For example, if filter 500 is designed to be a functional analog of an N-tap time-domain FIR filter, such as filter 400, then transfer function H(ƒ) applied by module 520 can be related to coefficients C₁-C_{N} applied by multipliers 420₁-420_{N} to the respective tapped signals in filter 400, for example, as follows:

$$H ( f ) = {\sum }_{n = 1}^{N} {C}_{n} {e}^{- 2 π j ( n - 1 ) f τ} \qquad ( 4 )$$

In one embodiment, filter 500 is configured to operate by repeating the sequence of operations described in the next paragraph on a set of digital values provided by input signal 502, with the set being located within a time window having M time slots and with said time window being slid forward by M−N+1 time slots each time the sequence is completed.

A serial-to-parallel (S/P) converter 510 generates a set 512 of M−N+1 digital values, e.g., by placing the digital values received via input signal 502, in the order of their arrival, into appropriate positions (lines) within set 512. An overlap module 514 converts set 512 into a set 516 of M digital values, e.g., by adding an appropriate number of digital values from the end of the preceding set 512. FFT module 520 then applies a Fourier transform to set 516, thereby generating a set 522 of M spectral samples. Transfer-function-application module 530 applies transfer function H(ƒ) to set 522, thereby generating a corrected set 532 of M spectral samples. IFFT module 540 applies an inverse Fourier transform to set 532, thereby generating a set 542 of M corrected digital values. A truncating module 550 truncates set 542 down to M−N+1 digital values, e.g., by removing an appropriate number of digital values from the beginning of set 542 or from the end of set 542, or both. The result is a truncated set 552 having M−N+1 corrected digital values. Finally, a parallel-to-serial (P/S) converter 560 serializes truncated set 552, thereby generating a corresponding segment of filtered output signal 562.

One of ordinary skill in the art will appreciate that filters 400 (FIG. 4) and 500 (FIG. 5) are but two examples of digital filters that can be used as individual equalization filters in filter bank 300 (FIG. 3). More specifically, FIR filters different from FIR filter 400 (e.g., an FIR filter with decision feedback) can similarly be used. A suitable FIR filter with decision feedback is disclosed, e.g., in each of U.S. Pat. No. 6,650,702 and U.S. Patent Application Publication Nos. 2002/0186762 and 2002/0191689, all of which are incorporated herein by reference in their entirety. Frequency-domain filters different from filter 500 may also be used. For example, a suitable frequency-domain filter is disclosed, e.g., in U.S. Pat. No. 8,050,336, which is incorporated herein by reference in its entirety.

FIG. 6 shows a block diagram of an equalizer 600 that can be used as MIMO equalizer 240 (FIG. 2) according to an embodiment of the disclosure. Equalizer 600 is shown in FIG. 6 as being configured to receive digital signals 236₁-236₈ and to output the generated complex values sₓ and s_{y} on lines 242a and 242b, respectively (also see FIG. 2). As explained above, in embodiments where co-processor 234 is not present, equalizer 600 can similarly be configured to receive digitals signals 222₁-222₈.

Equalizer 600 comprises an array 610 of thirty-two equalization filters, each marked in FIG. 3 using the filter's transfer function, Hₗₘ, where l=1, 2, 3, 4 and m=1, 2, . . . , 8. Possible embodiments of individual equalization filters used in array 610 are shown in FIGS. 4-5. Together with adders 620₁-620₄, filter array 610 implements the signal transform expressed by Eq. (5):

$${d}_{l} = {\sum }_{m = 1}^{8} {H}_{l m} * {c}_{m} \qquad ( 5 )$$

where dₗ is the l-th component of intermediate vector D, where l=1, 2, 3, 4; cₘ is the m-th component of input vector C, where m=1, 2, . . . , 8; Hₗₘ is a transfer function of the respective filter; and the “*” symbol denotes the convolution operation. In each time slot, input-vector component cₘ has a value provided by digital signal 236ₘ, and digital signal 622₁ carries a corresponding value of output-vector component dₗ. All transfer functions Hₗₘ are real-valued and controlled by controller 268 via control signal 238. Control signal 238 is a multi-component control signal that can be updated more frequently than the update frequency of control signal 232 (see FIG. 2).

Equalizer 600 further comprises real-to-complex (R/C) converters 630₁ and 630₂ configured to transform intermediate vector D into a pair of complex values, e.g., sₓ and s_{y}, in accordance with Eqs. (6a) and (6b):

sₓ=d₁+jd₂ (6a)

s_{y}=d₃+jd₄ (6b)

Equalizer 600 then directs this pair of complex values, via bus 242, to carrier-recovery circuits 250a-250b (see FIG. 2). Note that, unlike filter bank 300 (FIG. 3), equalizer 600 can mix digital signals 236 corresponding to the I and Q signals and/or corresponding to different polarization components of optical input signal 102 (FIG. 1).

According to an example embodiment disclosed above in reference to FIGS. 1-6, provided is an apparatus comprising: an optical-to-electrical converter (e.g., 120, FIG. 1) configured to mix an optical input signal (e.g., 102, FIG. 1) and an optical reference signal (e.g., 112, FIG. 1) to generate a first plurality of electrical digital measures (e.g., 152₁-152₄, FIG. 1) of the optical input signal; and a digital processor (e.g., 160, FIG. 1; 200, FIG. 2) configured to process the first plurality of electrical digital measures to recover data encoded in the optical input signal. The digital processor comprises: a first equalizer stage (e.g., 220a-220b, FIG. 2; 300, FIG. 3) configured to perform chromatic-dispersion-compensation processing on the first plurality of electrical digital measures to generate a second plurality of electrical digital measures (e.g., 222₁-222₈ or 236₁-236₈; FIG. 2) of the optical input signal; and a second equalizer stage (e.g., 240, FIG. 2; 600, FIG. 6) configured to perform signal-equalization processing on the second plurality of electrical digital measures to generate one or more complex-valued digital measures (e.g., 242a-242b; FIG. 2, FIG. 6) of the optical input signal. The digital processor is configured to generate the second plurality of electrical digital measures in a manner that does not mix different electrical digital measures of the first plurality of electrical digital measures prior to the signal-equalization processing in the second equalizer stage. The digital processor is configured to recover the data (e.g., for 162, FIG. 1, FIG. 2) carried by the optical input signal based on the one or more complex-valued digital measures.

In some embodiments of the above apparatus, the digital processor is configured to generate the second plurality of electrical digital measures using exclusively real-valued arithmetic (e.g., without the application of complex-valued arithmetic and/or real-to-complex and complex-to-real value conversions in 220 and 234; FIG. 2).

In some embodiments of any of the above apparatus, the first plurality of electrical digital measures consists of a first number of electrical digital measures; and the second plurality of electrical digital measures consists of a second number of electrical digital measures that is greater than the first number by a factor of two.

In some embodiments of any of the above apparatus, the first number is two; and the second number is four (e.g., when only one polarization of 102 is being used in the transmission and processed in 100, FIG. 1).

In some embodiments of any of the above apparatus, the first number is four; and the second number is eight (e.g., as shown in FIG. 2).

In some embodiments of any of the above apparatus, the first equalizer stage comprises a plurality of finite-impulse-response filters (e.g., 400, FIG. 4), each configured to process a respective one of the first plurality of electrical digital measures to generate a respective one of the second plurality of electrical digital measures.

In some embodiments of any of the above apparatus, the first equalizer stage is configured to direct at least one of the first plurality of electrical digital measures (e.g., 212₁, FIG. 3) for processing in two different finite-impulse-response filters (e.g., H₁₁ and H₂₁, FIG. 3) of the plurality of finite-impulse-response filters.

In some embodiments of any of the above apparatus, the first equalizer stage is configured to direct each of the first plurality of electrical digital measures for processing in respective two different finite-impulse-response filters of the plurality of finite-impulse-response filters (e.g., as shown in FIG. 3).

In some embodiments of any of the above apparatus, the first equalizer stage comprises eight finite-impulse-response filters (e.g., 400, FIG. 4), each configured to process a respective one of the first plurality of electrical digital measures to generate a respective one of the second plurality of electrical digital measures.

In some embodiments of any of the above apparatus, the eight finite-impulse-response filters include four finite-impulse-response filters (e.g., H₁₁, H₄₂, H₅₃, H₈₄, FIG. 3), each of which is configured to have a first transfer function (see Eq. (2a)).

In some embodiments of any of the above apparatus, the eight finite-impulse-response filters include: two finite-impulse-response filters (e.g., H₂₁, H₆₃, FIG. 3), each of which is configured to have a first transfer function (see Eq. (2b)); and another two finite-impulse-response filters (e.g., H₃₂, H₇₄, FIG. 3), each of which is configured to have a second transfer function that is a negative of the first transfer function (see Eq. (2b)).

In some embodiments of any of the above apparatus, the eight finite-impulse-response filters further include four finite-impulse-response filters (e.g., H₁₁, H₄₂, H₅₃, H₈₄, FIG. 3), each of which is configured to have a third transfer function (see Eq. (2a)).

In some embodiments of any of the above apparatus, the third transfer function is configured to approximate a real part (e.g., H_{RE}) of an inverse transfer function corresponding to chromatic dispersion in the optical input signal; and the first transfer function is configured to approximate an imaginary part (e.g., H_{IM}) of said inverse transfer function.

In some embodiments of any of the above apparatus, the digital processor does not have real-to-complex converters configured to operate on digital signals derived from the first plurality of electrical digital measures and located in the first equalizer stage and circuits between the first equalizer stage and the second equalizer stage.

In some embodiments of any of the above apparatus, the second equalizer stage comprises a plurality of finite-impulse-response filters (e.g., 400, FIG. 4), each configured to process a respective one of the second plurality of electrical digital measures to generate a respective one of a third plurality of electrical digital measures.

In some embodiments of any of the above apparatus, the second equalizer stage is configured to direct at least one of the second plurality of electrical digital measures (e.g., 236₁, FIG. 6) for processing in four different finite-impulse-response filters (e.g., H₁₁-H₄₁, FIG. 6) of the plurality of finite-impulse-response filters.

In some embodiments of any of the above apparatus, the second equalizer stage is configured to direct each of the second plurality of electrical digital measures for processing in respective four different finite-impulse-response filters of the plurality of finite-impulse-response filters (e.g., as shown in FIG. 6).

In some embodiments of any of the above apparatus, each of the electrical digital measures in the first, second, and third pluralities of electrical digital measures is a real-valued electrical digital measure.

In some embodiments of any of the above apparatus, the second equalizer stage further comprises a plurality of adders (e.g., 620₁-620₄, FIG. 6), each configured to sum respective eight electrical digital measures of the third plurality of electrical digital measures to generate a respective summed value; and each of the respective eight electrical digital measures has been generated from a different one of the plurality of the second plurality of electrical digital measures.

In some embodiments of any of the above apparatus, the second equalizer stage further comprises:
a first real-to-complex converter (e.g., 630₂, FIG. 6) configured to combine a first and a second of the respective summed values to generate a first (e.g., 242a, FIG. 6) of the one or more complex-valued digital measures; and
a second real-to-complex converter (e.g., 630₂, FIG. 6) configured to combine a third and a fourth of the respective summed values to generate a second (e.g., 242b, FIG. 6) of the one or more complex-valued digital measures.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

What is claimed is:

1. An apparatus comprising:
an optical-to-electrical converter configured to mix an optical input signal and an optical reference signal to generate a first plurality of electrical digital measures of the optical input signal; and
a digital processor configured to process the first plurality of electrical digital measures to recover data encoded in the optical input signal;
wherein the digital processor comprises:
a first equalizer stage configured to perform chromatic-dispersion-compensation processing on the first plurality of electrical digital measures to generate a second plurality of electrical digital measures of the optical input signal; and
a second equalizer stage configured to perform signal-equalization processing on the second plurality of electrical digital measures to generate one or more complex-valued digital measures of the optical input signal;
wherein the digital processor is configured to generate the second plurality of electrical digital measures in a manner that does not mix different electrical digital measures of the first plurality of electrical digital measures prior to the signal-equalization processing in the second equalizer stage; and
wherein the digital processor is configured to recover the data carried by the optical input signal using the one or more complex-valued digital measures.

2. The apparatus of claim 1, wherein the digital processor is configured to generate the second plurality of electrical digital measures using exclusively real-valued arithmetic.

3. The apparatus of claim 1, wherein:
the first plurality of electrical digital measures consists of a first number of electrical digital measures; and
the second plurality of electrical digital measures consists of a second number of electrical digital measures that is greater than the first number by a factor of two.

4. The apparatus of claim 3, wherein:
the first number is two; and
the second number is four.

5. The apparatus of claim 3, wherein:
the first number is four; and
the second number is eight.

6. The apparatus of claim 1, wherein the first equalizer stage comprises a plurality of finite-impulse-response filters, each configured to process a respective one of the first plurality of electrical digital measures to generate a respective one of the second plurality of electrical digital measures.

7. The apparatus of claim 6, wherein the first equalizer stage is configured to direct at least one of the first plurality of electrical digital measures for processing in two different finite-impulse-response filters of the plurality of finite-impulse-response filters.

8. The apparatus of claim 6, wherein the first equalizer stage is configured to direct each of the first plurality of electrical digital measures for processing in respective two different finite-impulse-response filters of the plurality of finite-impulse-response filters.

9. The apparatus of claim 1, wherein the first equalizer stage comprises eight finite-impulse-response filters, each configured to process a respective one of the first plurality of electrical digital measures to generate a respective one of the second plurality of electrical digital measures.

10. The apparatus of claim 9, wherein the eight finite-impulse-response filters include four finite-impulse-response filters, each of which is configured to have a first transfer function.

11. The apparatus of claim 9, wherein the eight finite-impulse-response filters include
two finite-impulse-response filters, each of which is configured to have a first transfer function; and
another two finite-impulse-response filters, each of which is configured to have a second transfer function that is a negative of the first transfer function.

12. The apparatus of claim 11, wherein the eight finite-impulse-response filters further include four finite-impulse-response filters, each of which is configured to have a third transfer function.

13. The apparatus of claim 12, wherein:
the third transfer function is configured to approximate a real part of an inverse transfer function corresponding to chromatic dispersion in the optical input signal; and
the first transfer function is configured to approximate an imaginary part of said inverse transfer function.

14. The apparatus of claim 1, wherein the digital processor does not have real-to-complex converters configured to operate on digital signals derived from the first plurality of electrical digital measures and located in the first equalizer stage and circuits between the first equalizer stage and the second equalizer stage.

15. The apparatus of claim 1, wherein the second equalizer stage comprises a plurality of finite-impulse-response filters, each configured to process a respective one of the second plurality of electrical digital measures to generate a respective one of a third plurality of electrical digital measures.

16. The apparatus of claim 15, wherein the second equalizer stage is configured to direct at least one of the second plurality of electrical digital measures for processing in four different finite-impulse-response filters of the plurality of finite-impulse-response filters.

17. The apparatus of claim 15, wherein the second equalizer stage is configured to direct each of the second plurality of electrical digital measures for processing in respective four different finite-impulse-response filters of the plurality of finite-impulse-response filters.

18. The apparatus of claim 15, wherein each of the electrical digital measures in the first, second, and third pluralities of electrical digital measures is a real-valued electrical digital measure.

19. The apparatus of claim 15,
wherein the second equalizer stage further comprises a plurality of adders, each configured to sum respective eight electrical digital measures of the third plurality of electrical digital measures to generate a respective summed value; and
wherein each of the respective eight electrical digital measures is generated from a different one of the plurality of the second plurality of electrical digital measures.

20. The apparatus of claim 19, wherein the second equalizer stage further comprises:
a first real-to-complex converter configured to combine a first and a second of the respective summed values to generate a first of the one or more complex-valued digital measures; and
a second real-to-complex converter configured to combine a third and a fourth of the respective summed values to generate a second of the one or more complex-valued digital measures.
